(19) United States
(12) Patent Application Publication
(10) Pub. No.: US 2004/0191687 A1
(43) Pub. Date: Sep. 30, 2004

(54) Optical recording medium

(75) Inventors: Narutoshi Fukuzawa, Tokyo (JP); Tsuyoshi Komaki, Tokyo (JP); Tomoki Ushida, Tokyo (JP)

Correspondence Address: SEED INTELLECTUAL PROPERTY LAW GROUP PLLC, 701 FIFTH AVE, SUITE 6300, SEATTLE, WA, 98104-7092, US

(73) Assignee: TDK Corporation, Tokyo (JP)

(21) Appl. No.: 10/808,963

(22) Filed: Mar. 25, 2004

(30) Foreign Application Priority Data
Mar. 28, 2003 (JP) 2003-090849

(51) Int. Cl. G11B 7/24

(52) U.S. Cl. 430/270.11

(57) ABSTRACT

An optical recording medium includes a support substrate, a light transmission layer and a recording layer located between the support substrate and the light transmission layer and containing an organic dye as a primary component, the light transmission layer including a first light transmission film located on the side of the recording layer and having Vickers hardness of 30 mgf/μm² to 50 mgf/μm² with respect to a load of 200 mgf and a second light transmission film located on the side of a light incidence plane through which a laser beam enters.

The thus constituted optical recording medium can achieve improved recording sensitivity and other recording characteristics and improved jitter property and other reproduced signal characteristics.

### BACKGROUND OF THE INVENTION

The present invention relates to an optical recording medium and, particularly, to an optical recording medium including a recording layer containing an organic dye as a primary component and a light transmission layer, which can improve the recording sensitivity and other recording characteristics of the optical recording medium as well as jitter property and other signal characteristics of a reproduced signal.

### DESCRIPTION OF THE PRIOR ART

Optical recording media such as the CD, DVD and the like have been widely used as recording media for recording digital data. These optical recording media can be roughly classified into optical recording media such as the CD-ROM and the DVD-ROM that do not enable writing and rewriting of data (ROM type optical recording media), optical recording media such as the CD-R and DVD-R that enable writing but not rewriting of data (write-once type optical recording media), and optical recording media such as the CD-RW and DVD-RW that enable rewriting of data (data rewritable type optical recording media).

As well known in the art, data are generally recorded in a ROM type optical recording medium using prepits formed in a substrate in the manufacturing process thereof, while in a data rewritable type optical recording medium a phase change material is generally used as the material of the recording layer and data are recorded utilizing changes in an optical characteristic caused by phase change of the phase change material.

On the other hand, in a write-once type optical recording medium, an organic dye such as a cyanine dye, phthalocyanine dye or azo dye is generally used as the material of the recording layer and data are recorded utilizing changes in an optical characteristic caused by chemical change of the organic dye, which change may be accompanied by physical deformation.

Unlike data recorded in a data rewritable type optical recording medium, data recorded in a write-once type optical recording medium cannot be erased and rewritten. This means that data recorded in a write-once type optical recording medium cannot be falsified, so that the write-once type optical recording medium is useful in the case where it is necessary to prevent data recorded in an optical recording medium from being falsified.

When data are recorded in the write-once type optical recording medium, it is normal not only for an organic dye contained in the recording layer to be chemically changed but also for the support substrate and layers close to the recording layer to be physically deformed. However, a write-once type optical recording medium having a recording layer containing an organic dye includes a reflective layer composed of metal having high thermal conductivity located on the side of the recording layer opposite-from the side of the light incidence plane so as to be adjacent to the recording layer. Layers located on the same side of the recording layer as the incidence plane and the support substrate are therefore liable to be physically deformed. Although this increases modulation of a reproduced signal and the recording sensitivity of the optical recording medium, it also creates a risk of a reproduced signal being degraded and adjacent tracks being affected when these layers are physically deformed too much.

On the other hand, a next-generation type optical recording medium that offers improved recording density and has an extremely high data transfer rate has been recently proposed.

In such a next-generation type optical recording medium, the achievement of increased recording capacity and extremely high data transfer rate inevitably requires the diameter of the laser beam spot used to record and reproduce data to be reduced to a very small size.

In order to reduce the laser beam spot diameter, it is necessary to increase the numerical aperture of the objective lens for condensing the laser beam to 0.7 or more, for example, to about 0.85, and to shorten the wavelength of the laser beam to 450 nm or less, for example, to about 400 nm.

In other words, it is necessary to set the ratio λ/NA of the wavelength λ of the laser beam to the numerical aperture NA of the objective lens to be equal to or smaller than 640 nm.

However, if the numerical aperture of the objective lens for condensing the laser beam is increased, then, as shown by Equation (1), the permitted tilt error of the optical axis of the laser beam to the optical recording medium, namely, the tilt margin T, has to be greatly decreased.

$$T ∝ \frac{λ}{d \cdot {NA}^{3}} \qquad ( 1 )$$

In Equation (1), λ is the wavelength of the laser beam used for recording and reproducing data and d is the thickness of the light transmission layer through which the laser beam transmits.

As apparent from Equation (1), the tilt margin T decreases as the numerical aperture of the objective lens increases and increases as the thickness of the light transmission layer decreases. Therefore, decrease of the tilt margin T can be effectively prevented by making the thickness of the light transmission layer thinner.

On the other hand, a wave aberration coefficient W representing coma is defined by Equation (2).

$$W = \frac{d \cdot ( {n}^{2} - 1 ) \cdot {n}^{2} \cdot sin θ \cdot cos θ \cdot {( NA )}^{3}}{2 {λ ( {n}^{2} - {sin}^{2} θ )}^{\frac{5}{2}}} \qquad ( 2 )$$

In Equation (2), n is the refractive index of the light transmission layer and θ is the tilt of the optical axis of the laser beam.

As apparent from Equation (2), coma can also be very effectively suppressed by making the thickness of the light transmission layer thinner.

For these reasons, it has been proposed that the thickness of the light transmission layer of the next-generation type optical recording medium should be reduced as far as about 100 μm in order to ensure sufficient tilt margin and suppress coma.

As a result, it becomes difficult to form a layer such as a recording layer on the support substrate which has a light transmission property and through which a laser beam enters as is done in conventional optical recording media such as the CD and DVD. This led to the proposal that the light transmission layer be constituted as a thin resin layer formed by spin coating or the like on a recording layer or other such layer formed on a support substrate.

Accordingly, although layers are sequentially formed from the side of the light incidence surface in a conventional optical recording medium, they are sequentially formed from the side opposite from the light incidence surface in a next-generation optical recording medium.

Owing to these requirements, it has been proposed that as the material for forming a light transmission layer of a next-generation optical recording medium there be used an ultraviolet ray curable resin having high viscosity suitable for a spin coating process and a small shrinkage ratio during hardening and the like. As a preferable ultraviolet ray curable resin having high viscosity suitable for a spin coating process and a small shrinkage ratio during hardening, there has been proposed an ultraviolet ray curable resin having an oligomer component having a relatively high molecular weight and a small number of functional groups.

However, such an ultraviolet ray curable resin has low hardness. Therefore, when a light transmission layer formed of such ultraviolet ray curable resin is provided in an optical recording medium having a recording layer containing an organic dye and data are recorded in the optical recording medium, the light transmission layer is liable to be physically deformed, thereby greatly affecting recording characteristics of the optical recording medium, such as the recording sensitivity, and signal characteristics of a reproduced signal, such as jitter.

### SUMMARY OF THE INVENTION

It is therefore an object of the present invention to provide an optical recording medium including a recording layer containing an organic dye as a primary component and a light transmission layer, which can improve the recording sensitivity and other recording characteristics of the optical recording medium as well as jitter property and other signal characteristics of a reproduced signal.

The inventors of the present invention vigorously pursued a study for accomplishing the above object and, as a result, made the discovery that in an optical recording medium which had a support substrate, a light transmission layer formed on a side of a light incidence plane through which a laser beam was projected and comprising at least one light transmission film and a recording layer located between the support substrate and the light transmission layer and containing an organic dye as a primary component, in the case where the at least one light transmission film had Vickers hardness of 30 mgf/μm² to 50 mgf/μm², the recording characteristics of the optical recording medium and the characteristics of a signal reproduced from the optical recording medium could be simultaneously improved.

The Vickers hardness is hardness measured by the diamond-pyramid hardness test defined in JISZ2244 and JISR1410 using a test load of 200 mgf.

More specifically, in a study done by the inventors of the present invention, it was found that as shown in FIG. 1, jitter of a signal reproduced from the optical recording medium decreased as the hardness of the at least one light transmission film became high but jitter of a reproduced signal became substantially constant when the Vickers hardness of the at least one light transmission film reached 30 mgf/μm² to 33 mgf/μm² and instead, jitter inversely increased as the Vickers hardness of the at least one light transmission film increased.

It is reasonable to conclude that this is because as the hardness of the at least one light transmission film increases, excessive physical deformation of a region of the light transmission layer corresponding to the region of the recording layer where a record pit is formed is suppressed, whereby jitter of a signal reproduced from the optical recording medium decreases but when the Vickers hardness of the at least one light transmission film reaches 30 mgf/μm² to 33 mgf/μm², physical deformation of a region of the light transmission layer corresponding to the region of the recording layer where a record pit is formed decreases, whereby the jitter reduction effect vanishes, and as the Vickers hardness of the at least one light transmission film further increases, a region of the light transmission layer corresponding to the region of the recording layer where a record pit is formed experience almost no physical deformation and change in an optical path length between before and after recording of data becomes too small to decrease modulation, so that jitter becomes worse.

Therefore, in order to decrease jitter of a signal reproduced from the optical recording medium, the at least one light transmission film preferably has Vickers hardness equal to or higher than 30 mgf/μm² and more preferably has Vickers hardness equal to or higher than 33 mgf/μm².

To the contrary, in a study done by the inventors of the present invention, it was found that as shown in FIG. 1, as the hardness of the at least one light transmission film decreased, the optimum recording power of a laser beam for recording data in the optical recording medium, namely the recording power of the laser beam at which jitter of a signal reproduced from the optical recording medium became lowest, decreased, and therefore, the recording sensitivity of the optical recording medium improved as the hardness of the at least one light transmission film decreased.

It is reasonable to conclude that this is because as the hardness of the at least one light transmission film decreases, a region of the light transmission layer irradiated with a laser beam is liable to be physically deformed and even if a laser beam projected onto the optical recording medium has a low recording power, it is possible to form a record pit in the recording layer and physically deform the region of the light transmission layer corresponding to the record pit.

Therefore, in order to increase the recording sensitivity of the optical recording medium, it is preferable for the at least one light transmission film to have low hardness.

On the other hand, a material having high hardness generally has a number of functional groups (active sites) used for polymerization in order to increase the density of cross-linkage of monomers and, therefore, when the at least one light transmission film is made of a material having high hardness, it shrinks markedly during hardening by irradiation with ultraviolet rays. Further, since the at least one light transmission film contains a number of unreacted functional groups (active sites) which have not yet polymerized with each other after being irradiated with ultraviolet rays, in the case where the optical recording medium is stored at a high temperature, these unreacted functional groups (active sites) gradually polymerize with each other and the at least one light transmission film gradually hardens to be shrunk. Therefore, in the case where the at least one light transmission film is made of a material having high hardness, when the at least one light transmission film is hardened and the optical recording medium is stored at a high temperature, the at least one light transmission film greatly shrinks, whereby the optical recording medium is liable to be bent, cracks may be generated in the optical recording medium and the mechanical strength of the optical recording medium is lowered.

In view of the above, it is preferable for the at least one light transmission film to have low hardness in order to increase the recording sensitivity of the optical recording medium and prevent the mechanical strength of the optical recording medium from being lowered but on the other hand, it is preferable for the at least one light transmission film to have high hardness in order to improve the jitter property and other characteristics of a signal reproduced from the optical recording medium. However, in a study done by the inventors of the present invention, it was found that in the case where the at least one light transmission film had Vickers hardness of 30 mgf/μm² to 50 mgf/μm², it was possible to improve the recording characteristics of the optical recording medium and prevent the mechanical strength of the optical recording medium from being lowered and it was possible to simultaneously improve the characteristics of a signal reproduced from the optical recording medium.

The present invention is based on this finding and, according to the present invention, the above and other objects of the present invention can be accomplished by an optical recording medium comprising a support substrate, a light transmission layer formed on a side of a light incidence plane through which a laser beam is projected and comprising at least one light transmission film and a recording layer located between the support substrate and the light transmission layer and containing an organic dye as a primary component, the at least one light transmission film having Vickers hardness of 30 mgf/μm² to 50 mgf/μm² with respect to a load of 200 mgf.

In a preferred aspect of the present invention, the at least one light transmission film has Vickers hardness of 33 mgf/μm² to 50 mgf/μm².

In a further preferred aspect of the present invention, the at least one light transmission film has Vickers hardness of 33 mgf/μm² to 42 mgf/μm².

In the present invention, it is preferable to form the at least one light transmission film so as to have a thickness of 0.5 μm to 100 μm and it is more preferable to form the at least one light transmission film so as to have a thickness of 0.5 μm to 50 μm.

In the case where the at least one light transmission film has a thickness thinner than 0.5 μm, it is difficult to improve the recording characteristics of the optical recording medium and the characteristics of a signal reproduced from the optical recording medium and on the other hand, in the case where the at least one light transmission film has a thickness thicker than 100 μm, the optical recording medium is liable to be bent and cracks are liable to be generated in the optical recording medium.

In the present invention, the thickness of the light transmission layer is preferably equal to or thicker than 10 μm and equal to or thinner than 300 μm and is more preferably 10 μm to 150 μm.

In a preferred aspect of the present invention, the at least one first light transmission film is formed by applying a resin solution using a spin coating process.

In a preferred aspect of the present invention, the light transmission layer comprises a first light transmission film which is located on the side of the recording layer and has Vickers hardness of 30 mgf/μm² to 50 mgf/μm² with respect to a load of 200 mgf and a second light transmission film located on the side of a light incidence plane through which a laser beam enters.

In a study done by the inventors of the present invention, it was found that in the case where the light transmission layer comprised a first light transmission film located on the side of the recording layer and a second light transmission film located on the side of a light incidence plane through which a laser beam entered, in order to improve the characteristics of a signal reproduced from an optical recording medium, it was preferable to form the first light transmission film of a material having high hardness and that on the other hand, in order to improve data recording characteristics of the optical recording medium such as the recording sensitivity and the mechanical strength of the optical recording medium, it was preferable to form the first light transmission film of a material having low hardness.

Therefore, in the present invention, in the case where the light transmission layer comprises a first light transmission film located on the side of the recording layer and a second light transmission film located on the side of a light incidence plane through which a laser beam enters, it is preferable for the first light transmission film to have Vickers hardness of 33 mgf/μm² to 50 mgf/μm².

In a further preferred aspect of the present invention, the first light transmission film has Vickers hardness of 33 mgf/μm² to 42 mgf/μm².

In the present invention, it is preferable to form the first light transmission film so as to have a thickness of 0.5 μm to 100 μm and it is more preferable to form the first light transmission film so as to have a thickness of 0.5 μm to 50 μm.

In the case where the first light transmission film has a thickness thinner than 0.5 μm, it is difficult to improve the recording characteristics of the optical recording medium and the characteristics of a signal reproduced from the optical recording medium and in the case where the first light transmission film has a thickness thicker than 100 μm, the optical recording medium is liable to be bent and cracks are liable to be generated in the optical recording medium.

In the present invention, in the case where the light transmission layer comprises a first light transmission film located on the side of the recording layer and a second light transmission film located on the side of a light incidence plane through which a laser beam enters, in order to prevent the optical recording medium from being bent and improve the mechanical strength of the optical recording medium, it is particularly preferable for the second light transmission film to have hardness lower than that of the first light transmission film.

On the other hand, it is preferable for the second light transmission film to have high hardness in order to prevent the surface thereof being damaged.

Therefore, concretely, in the present invention, it is preferable for the second light transmission film to have Vickers hardness of about 0.2 mgf/μm² to about 25 mgf/μm².

In the present invention, the total thickness of the first light transmission film and the second light transmission film is preferably equal to or thicker than 10 μm and equal to or thinner than 300 μm and is more preferably 10 μm to 150 μm.

In a preferred aspect of the present invention, each of the first light transmission film and the second light transmission film is formed by applying a resin solution using a spin coating process.

In another preferred aspect of the present invention, the first light transmission film is constituted as an adhesive layer formed of a light transmittable adhesive agent layer and the second light transmission film is formed by adhering a light transmittable sheet onto the adhesive layer.

In a preferred aspect of the present invention, the optical recording medium further comprises a reflective layer between the support substrate and the recording layer.

According to this preferred aspect of the present invention, since the reflective layer not only serves to reflect a laser beam entering the optical recording medium but also serves as a radiation layer to radiate heat generated when data are recorded, it is possible to prevent the support substrate from being excessively deformed.

In a preferred aspect of the present invention, the optical recording medium further comprises a cap layer between the light transmission layer and the recording layer.

According to this preferred aspect of the present invention, since the cap layer is provided between the light transmission layer and the recording layer and the light transmission layer is not in contact with the recording layer, the first light transmission film can be easily formed.

In the present invention, the cap layer is formed of a dielectric material or metal.

In the present invention, in the case where the cap layer is formed of a dielectric material, it is preferable to form the cap layer so as to have a thickness of 10 nm to 150 nm and in the case where the cap layer is formed of metal, it is preferable to form the cap layer so as to have a thickness of 10 nm to 20 nm.

In a preferred aspect of the present invention, the optical recording medium is constituted so that data can be recorded therein by projecting a laser beam having a wavelength of 370 nm to 425 nm thereonto.

In the present invention, it is preferable for an organic dye contained in the recording layer as a primary component to have a refractive index lower than 1.2 or higher than 1.9 with respect to a laser beam having a wavelength of 370 nm to 425 nm and an extinction coefficient equal to or higher than 0.1 and equal to or lower than 1.0 with respect to a laser beam having a wavelength of 370 nm to 425 nm and it is more preferable for the recording layer to contain a porphyrin system dye, a mono-methine cyanine system dye or a tri-methine cyanine system dye as a primary component.

The above and other objects and features of the present invention will become apparent from the following description made with reference to the accompanying drawings.

### BRIEF DESCRIPTION OF THE DRAWINGS

FIG. 1 is a graph schematically showing how jitter of a signal reproduced from an optical recording medium and an optimum recording power of a laser beam vary with the Vickers hardness of a first light transmission film.

FIG. 2 is a schematic partially cutaway perspective view showing an optical recording medium that is a preferred embodiment of the present invention.

FIG. 3 is an enlarged schematic cross-sectional view of the part of the optical recording medium indicated by A in FIG. 1.

FIG. 4 is a schematic cross-sectional view showing an optical recording medium that is another preferred embodiment of the present invention.

### DESCRIPTION OF THE PREFERRED EMBODIMENTS

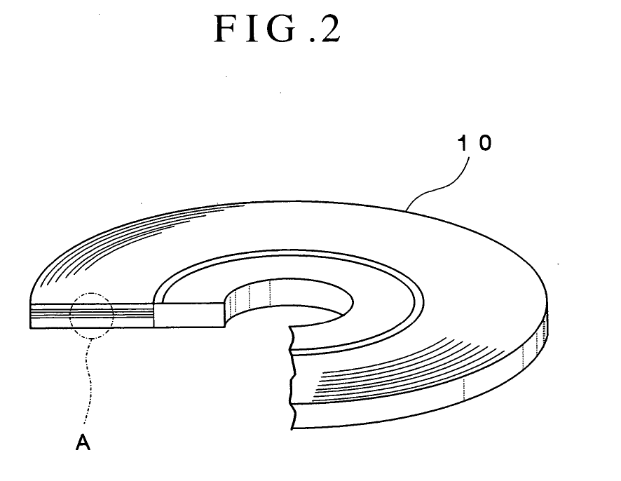

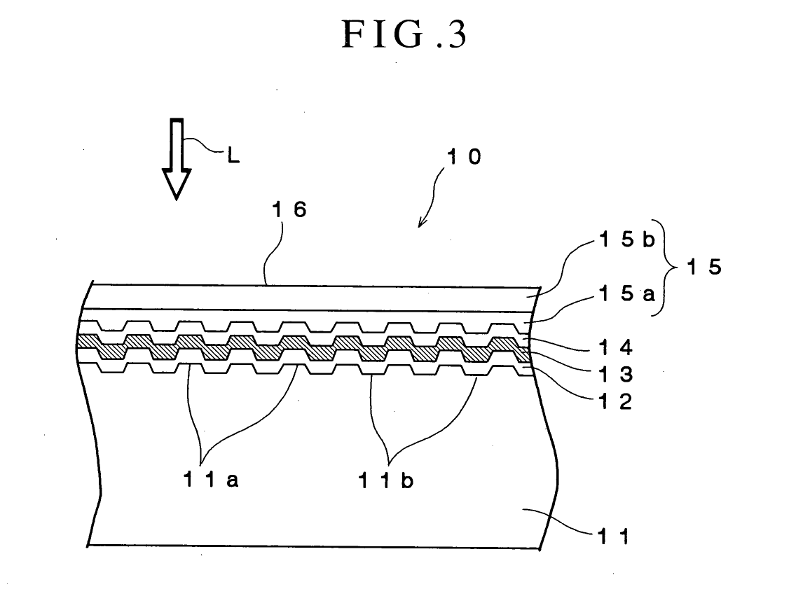

FIG. 2 is a schematic partially cut perspective view showing an optical recording medium that is a preferred embodiment of the present invention and FIG. 3 is a schematic enlarged cross-sectional view indicated by A in FIG. 2.

As shown in FIG. 2, an optical recording medium 10 according to this embodiment is formed disk-like and has an outer diameter of about 120 mm and a thickness of about 1.2 mm.

An optical recording medium 10 according to this embodiment is constituted as a write-once type optical recording medium and as shown in FIG. 3, it includes a support substrate 11, a reflective layer 12 formed on the surface of the support substrate 11, a recording layer 13 formed on the surface of the reflective layer 12, a cap layer 14 formed on the surface of the recording layer 14 and a light transmission layer 15 formed on the surface of the cap layer 14, in this order.

As shown in FIG. 3, the light transmission layer 15 includes a first light transmission film 15a and a second light transmission film 15b.

The optical recording medium 10 according to this embodiment is constituted so that a laser beam L having a wavelength λ of 380 nm to 450 nm is projected onto the recording layer 13 via the light transmission layer 15 and a light incidence plane 16 is formed by the surface of the second light transmission film 15b.

An objective lens having a numerical aperture NA equal to or larger than 0.65 and more preferably equal to about 0.85 is employed for projecting a laser beam L onto the optical recording medium 10. It is preferable to select the wavelength λ of a laser beam L and the numerical aperture NA of an objective lens so as to satisfy that λ/NA is equal to or smaller than 640 nm.

The support substrate 11 serves as a support for ensuring mechanical strength and a thickness of about 1.2 mm required for the optical recording medium 10.

The material used to form the support substrate 11 is not particularly limited insofar as the support substrate 11 can serve as the support of the optical recording medium 10. The support substrate 11 can be formed of glass, ceramic, resin or the like. Among these, resin is preferably used for forming the support substrate 11 since resin can be easily shaped. Illustrative examples of resins suitable for forming the support substrate 11 include polycarbonate resin, polyolefin resin, acrylic resin, epoxy resin, polystyrene resin, polyethylene resin, polypropylene resin, silicone resin, fluoropolymers, acrylonitrile butadiene styrene resin, urethane resin and the like. Among these, polycarbonate resin and polyolefin resin are most preferably used for forming the support substrate 11 from the viewpoint of easy processing, optical characteristics and the like and in this embodiment, the support substrate 11 is formed of polycarbonate resin. In this embodiment, since the laser beam L is projected onto the recording layer 13 via the light transmission layer 15 located opposite to the support substrate 11, it is unnecessary for the support substrate 11 to have a light transmittance property.

In this embodiment, the support substrate 11 has a thickness of about 1.1 mm.

As shown in FIG. 3, grooves 11a and lands 11b are alternately and spirally formed on the surface of the support substrate 11. The grooves 11a and/or lands 11b serve as a guide track for the laser beam L when data are to be recorded in the optical recording medium 10 or when data are to be reproduced from the optical recording medium 10.

The depth of the groove 11a and the pitch of the grooves 11a are not particularly limited but in order to obtain an optimum push-pull signal, the depth of the groove 11a is preferably set to 20 nm to 100 nm and the pitch of the grooves 11a is preferably set to 0.2 μm to 0.4 μm.

The reflective layer 12 serves to reflect the laser beam L entering through the light incidence plane 16 so as to emit it from the light incidence plane 16 and increase a reproduced signal (C/N ratio) by a multiple interference effect. The reflective layer 12 further serves to quickly radiate heat generated when data are recorded in the recording layer 13.

The material used to form the reflective layer 12 is not particularly limited insofar as it can reflect a laser beam, and the reflective layer 12 can be formed of Mg, Al, Ti, Cr, Fe, Co, Ni, Cu, Zn, Ge, Ag, Pt, Au or the like. Further, the reflective layer 12 can be formed of a dielectric material and illustrative examples of the dielectric material usable for forming the reflective layer 12 include an oxide, sulfide, nitride or carbide of Al, Si, Ce, Ti, Zn, Ta or the like, such as ZnO, ZnS, GeN, GeCrN, CeO₂, SiO, SiO₂, Si₃N₄, La₂O₃, TaO, TiO₂, SiAlON (mixture of SiO₂, Al₂O₃, Si₃N₄ and AlN), LaSiON (mixture of La₂O₃, SiO₂ and Si₃N₄) or the like, or a mixture thereof. In order to from a reflective layer 12 having high reflective coefficient, it is preferable to form the reflective layer 12 of a metal such as Al, Au, Ag, Cu or the like or an alloy thereof and among these and it is more preferable to form the reflective layer 12 of Ag or an alloy containing Ag as a primary component and a small amount of In, Sn, Zn, Cu, Pd, Bi or the like as an additive.

It is preferable to form the reflective layer 12 to have a thickness of 5 to 200 nm and is more preferable to form it to have a thickness of 10 to 100 nm.

In the case where the thickness of the reflective layer 12 is thinner than 5 nm, the above described effects cannot sufficiently be obtained. On the other hand, in the case where the thickness of the reflective layer 12 exceeds 200 nm, the surface smoothness of the reflective layer 12 is degraded and it takes a longer time for forming the reflective layer 12, thereby lowering the productivity of the optical recording medium 10.

The recording layer 13 is a layer in which data are to be recorded and contains an organic dye as a primary component.

It is sufficient for the recording layer 13 to contain 50 weight % of an organic dye or more and the recording layer 13 may be formed solely of an organic dye and unavoidable impurity.

The organic dye to be contained in the recording layer 13 is not particularly limited and illustrative examples of organic dyes to be contained in the recording layer 13 include dyes having high light absorption in a wavelength range in the vicinity of the wavelength of a laser beam used for recording data, such as a macrocyclic dye having a pyrrole ring such as a phthalocyanine derivative, an aza-porphyrin derivative, a porphycene derivative, a corrol derivative, a porphyrin derivative or the like; a coumarin derivative; an aza-oxonol metal chelate derivative; a benzotriazole derivative; a styryl derivative; a diphenyl-hexatriene derivative; a cyanine derivative or the like. These may be mixed in order to adjust optical characteristics and/or thermal characteristics of the recording layer 13. It is particularly preferable for the recording layer 13 to contain a porphyrin system dye, a mono-methine cyanine system dye or a tri-methine cyanine system dye.

Each of a porphyrin system dye, a mono-methine cyanine system dye and a tri-methine cyanine system dye preferably has a refractive index n lower than 1.2 or higher than 1.9 with respect to the laser beam having the wavelength of 370 to 425 nm and absorbs the laser beam having the wavelength of 390 to 420 nm to be melted or decomposed, whereby the refractive index thereof changes.

In the case where the recording layer 13 contains such a porphyrin system dye, a mono-methine cyanine system dye or a tri-methine cyanine system dye as a primary component, the dye absorbs the laser beam having the wavelength of 370 to 425 nm for recording data to be melted or decomposed, whereby the refractive index n with respect to the laser beam of a wavelength of 370 to 425 nm changes from a low value to a high value of, for example, 1.5 when the refractive index n of the dye is lower than 1.2 or the refractive index n changes from a high value to a low value of, for example, 1.5 when the refractive index n is higher than 1.9. Thus, a record pit is formed in the recording layer 13 and data are recorded therein. The reflective coefficient of a region of the recording layer 13 where the record pit is formed with respect to the laser beam having the wavelength of 370 to 425 nm is greatly different from that of regions around the region where the record pit is formed, so that the difference in reflective coefficients between the region where the record pit is formed and the regions therearound enables data to be recorded using the laser beam of a wavelength of 370 to 425 nm for recording data and data to be reproduced using the laser beam of a wavelength of 370 to 425 nm for reproducing data. In order to greatly change the refractive coefficient, the refractive index n within a wavelength range from 370 to 425 nm is preferably lower than 1.1 or higher than 2,0, more preferably, lower than 1.0 or higher than 2.1. The lower limit of the refractive index n is not particularly limited but is normally about 0.6 and the upper limit of the refractive index n is not particularly limited but is normally about 3.0.

Further, the extinction coefficient (imaginary part of the complex refractive index) k of the porphyrin system dye, the mono-methine cyanine system dye or the tri-methine cyanine system dye is preferably equal to or higher than 0.1 with respect to the laser beam for recording data and-the laser beam for reproducing data and more preferably equal to or higher than 0.3.

In the case where the extinction coefficient k of the porphyrin system dye, the mono-methine cyanine system dye or the tri-methine cyanine system dye with respect to the laser beam for recording data is equal to or higher than 0.1, the laser beam for recording data can be suitably absorbed by the dye at a position where a record pit is to be formed, whereby the temperature is increased locally and the refractive index readily changes due to melting or decomposition of the dye. Further, in the case where the extinction coefficient k of the porphyrin system dye, the mono-methine cyanine system dye or the tri-methine cyanine system dye with respect to the laser beam for recording data is equal to or higher than 0.3, data can be recorded in the recording layer 13 using a laser beam L having lower power. On the other hand, in the case where the extinction coefficient k of the porphyrin system dye, the mono-methine cyanine system dye or the tri-methine cyanine system dye with respect to the laser beam for recording data is lower than 0.1, the absorption of the laser beam for recording data is reduced and it is difficult to record data using a laser beam of ordinary recording power. Further, in the case where the extinction coefficient k of the porphyrin system dye, the mono-methine cyanine system dye or the tri-methine cyanine system dye with respect to the laser beam for reproducing data is equal to or higher than 0.1, the unrecorded regions have desired reflection coefficients and it is easy to read the difference in reflection coefficients between the record pit and unrecorded regions. However, the extinction coefficient k of the porphyrin system dye, the mono-methine cyanine system dye or the tri-methine cyanine system dye with respect to the laser beam for reproducing data is preferably equal to or lower than 1.0 because the reflective coefficient decreases if the extinction coefficient k of the dye with respect to the laser beam for reproducing data becomes too high. From these viewpoints, the extinction coefficient (imaginary part of the complex refractive index) k of the porphyrin system dye, the mono-methine cyanine system dye or the tri-methine cyanine system dye is preferably equal to or higher than 0.1 and equal to or lower than 1.0 with respect to the laser beam for recording data and the laser beam for reproducing data and more preferably equal to or higher than 0.3 and equal to or lower than 1.0.

In this embodiment, the recording layer 13 is formed so as to have a thickness of 15 nm to 150 nm at the portions of the lands 11b, more preferably, 20 nm to 80 nm. The recording layer 13 is formed to a thickness of 5 nm to 100 nm, preferably, 10 nm to 70 nm at the portions of the groove 11a. The thickness of the recording layer 13 is preferably designed with consideration to the desired reflective coefficient, modulation and heat interference between neighboring tracks and marks. Illustrative examples of parameters affecting these factors include the shape of the support substrate 11, the behavior of the dye when being thermally decomposed, the optical properties of the dye, the optical properties and thermal conductivity of neighboring layers and the like.

The cap layer 14 serves to prevent the materials used for forming the recording layer 13 and the material used for forming the light transmission layer 15 from mixing with each other at the interface between the recording layer 13 and the light transmission layer 15 when the light transmission layer 15 is formed and to adjust the optical characteristics of the optical recording medium 10. Therefore, in the case where the materials used for forming the recording layer 13 and the material used for forming the light transmission layer 15 are not mutually soluble and it is unnecessary to adjust the optical characteristics of the optical recording medium 10, it is not absolutely necessary to provide the cap layer 14.

The material for forming the cap layer 14 is not particularly limited insofar as it is an inorganic material having a sufficiently high light transmittance with respect to a laser beam L having a wavelength of 370 nm to 425 nm and the cap layer 14 can be formed of a dielectric material or a metal material.

The cap layer 14 can be formed of a dielectric material containing oxide, sulfide, nitride, carbide or a combination thereof, for example, as a primary component and in order to improve the characteristics of the cap layer 14 for protecting the recording layer 13, it is preferable to form the cap layer 14 of an oxide, sulfide, nitride or carbide of Al, Si, Ce, Ti, Zn, Ta or the like, such as Al₂O₃, AlN, ZnO, ZnS, GeN, GeCrN, CeO₂, SiO, SiO₂, Si₃N₄, SiC, La₂O₃, TaO, TiO₂, SiAlON (mixture of SiO₂, Al₂O₃, Si₃N₄ and AlN), LaSiON (mixture of La₂O₃, SiO₂ and Si₃N₄) or the like, or a mixture thereof, and it is particularly preferable to form the cap layer 14 of a mixture of ZnS and SiO₂. In the case where the cap layer 14 is formed of the mixture of ZnS and SiO₂, the mole ratio of ZnS to SiO₂ is preferably 80:20. The cap layer 14 may have a multi-layered structure including a plurality of films.

Further, in the case of forming the cap layer 14 of metal, it is preferable to form the cap layer 14 of Al, Au, Ag or Cu or an alloy thereof and it is more preferable to form the cap layer 14 of Ag or an alloy containing Ag as a primary component and a small amount of In, Sn, Zn, Cu, Pd, Bi or the like as an additive.

The thickness of the cap layer 14 is not particularly limited but in the case of forming the cap layer 14 of a dielectric material, it is preferable to form the cap layer 14 to have a thickness of 10 to 150 nm and is more preferable to form it to have a thickness of 20 to 70 nm.

In the case where the thickness of the cap layer 14 is thinner than 10 nm, the material used for forming the light transmission layer 15 penetrates the cap layer 14, thereby posing a risk of damaging the recording layer 13. On the other hand, in the case where the thickness of the cap layer 14 exceeds 150 nm, the thermal conductivity of the cap layer 14 becomes too high, so that a large amount of energy is necessary for causing an organic dye contained in the recording layer 13 to optically change, thereby posing a risk of lowering the recording sensitivity of the optical recording medium 10.

On the other hand, in the case where the cap layer 14 is formed of metal, it is preferable to form the cap layer 14 so as to have a thickness equal to or thicker than 10 nm and equal to or thinner than 20 nm in order to enable the cap layer 14 to have high light transmittance.

In the case where the light transmission layer 15 is excessively physically deformed when data are recorded in the recording layer 13, the recording characteristics and the reproduction characteristics of the optical recording medium 10 are affected. Therefore, it is necessary to prevent the cap layer 14 from being excessively physically deformed when data are recorded in the recording layer 13. However, in a study done by the inventors of the present invention, it was ascertained that in the case where the cap layer 14 was formed of a dielectric material and had a thickness equal to or thinner than 150 nm, it was difficult to prevent the cap layer 14 from being excessively physically deformed and that in the case where the cap layer 14 was formed of metal and had a thickness equal to or thinner than 20 nm, it was difficult to prevent the cap layer 14 from being excessively physically deformed.

The light transmission layer 15 serves to transmit a laser beam L and as shown in FIG. 3, it includes the first light transmission film 15a formed on the side of the support substrate 11 and the second light transmission film 15b whose surface constitutes the light incidence plane 16.

It is known that when data are recorded in a write-once type optical recording medium having a recording layer containing an organic dye as a primary component, it is normal not only for an organic dye contained in the recording layer to be chemically changed but also for the support substrate and layers close to the recording layer to be physically deformed and when a reflective layer made of metal is provided adjacent to the recording layer, layers such as a cap layer, a light transmission layer and the like on the side of the light incidence plane with respect to the recording layer are physically deformed, thereby increasing modulation of a reproduced signal and the recording sensitivity of the optical recording medium and that on the other hand, when the layers are physically deformed too much, there arise risks of a reproduced signal being degraded and adjacent tracks being affected.

The inventors of the present invention vigorously pursued a study for solving these problems and, as a result, made the discovery that in an optical recording medium 10 including a support substrate 11, a recording layer 13 containing an organic dye as a primary component, a first light transmission film 15a located on the side of the recording layer 13 and a second light transmission film 15b whose surface constituted the light incidence plane 16, in the case where the first light transmission film 15a had Vickers hardness of 30 mgf/μm² to 50 mgf/μm², the recording characteristics of the optical recording medium 10 and the characteristics of a signal reproduced from the optical recording medium 10 could be simultaneously improved.

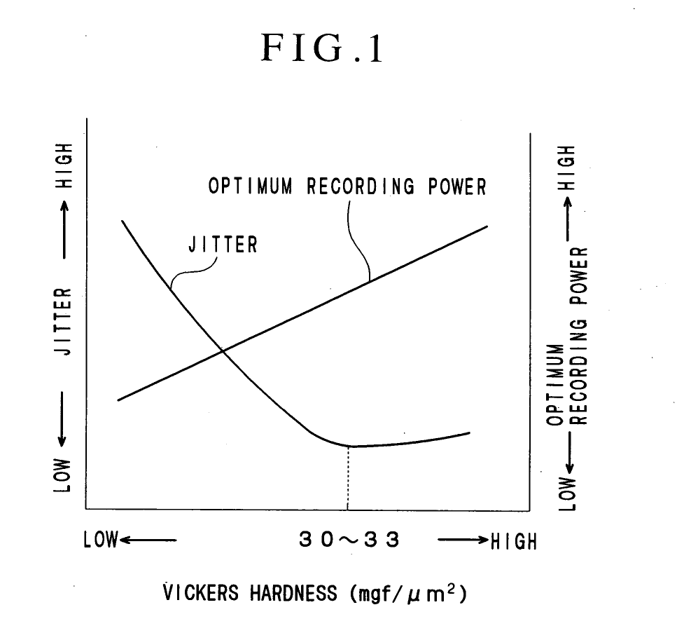

More specifically, in a study done by the inventors of the present invention, it was found that as shown in FIG. 1, jitter of a signal reproduced from the optical recording medium 10 decreased as the hardness of the first light transmission film 15a located on the side of the recording layer 13 became high but that jitter of a reproduced signal became substantially constant when the Vickers hardness of the first light transmission film 15a reached 30 mgf/μm² to 33 mgf/μm² and, to the contrary, increased with further increase of the Vickers hardness of the first light transmission film 15a.

It is reasonable to conclude that this is because as the hardness of the first light transmission film 15a increases, physical deformation of a region of the first light transmission film 15a corresponding to the region of the recording layer 13 where a record pit is formed is suppressed, whereby jitter of a signal reproduced from the optical recording medium 10 decreases but when the Vickers hardness of the first light transmission film 15a reaches 30 mgf/μm² to 33 mgf/μm², physical deformation of a region of the first light transmission film 15a corresponding to the region of the recording layer 13 where a record pit is formed decreases, whereby the jitter reduction effect vanishes and as the Vickers hardness of the first light transmission film 15a further increases, not only a region of the first light transmission film 15a but also a region of the support substrate 11 corresponding to the region of the recording layer 13 where a record pit is formed experience almost no physical deformation, so that jitter becomes worse.

Therefore, in order to decrease jitter of a signal reproduced from the optical recording medium 10, the first light transmission film 15a preferably has Vickers hardness equal to or higher than 30 mgf/μm² and more preferably has Vickers hardness equal to or higher than 33 mgf/μm².

To the contrary, in a study done by the inventors of the present invention, it was found that as shown in FIG. 1, as the hardness of the first light transmission film 15a decreased, the optimum recording power of a laser beam L for recording data in the optical recording medium, namely the recording power recording power of the laser beam L at which jitter of a signal reproduced from the optical recording medium 10 became lowest decreased, and therefore, the recording sensitivity of the optical recording medium 10 improved as the hardness of the first light transmission film 15a decreased.

It is reasonable to conclude that this is because as the hardness of the first light transmission film 15a decreases, a region of the first light transmission film 15a irradiated with a laser beam L is liable to be physically deformed and even if a laser beam projected onto the optical recording medium 10 has a low recording power, it is possible to form a record pit in the recording layer 13 and physically deform a region of the first light transmission film 15a corresponding to the record pit.

Therefore, in order to increase the recording sensitivity of the optical recording medium 10, it is preferable for the first light transmission film 15a to have low hardness.

On the other hand, a material having high hardness generally has a number of functional groups (active sites) used for polymerization in order to increase the density of cross-linkage of monomers and, therefore, when the first light transmission film 15a is made of a material having high hardness, it shrinks markedly during irradiation with ultraviolet rays. Further, since the first light transmission film 15a contains a number of unreacted functional groups (active sites) which have not yet polymerized with each other after being irradiated with ultraviolet rays, in the case where the optical recording medium 10 is stored at a high temperature, these unreacted functional groups (active sites) gradually polymerize with each other and the first light transmission film 15a gradually hardens to be shrunk. Therefore, in the case where the first light transmission film 15a is made of a material having high hardness, when the first light transmission film 15a is hardened and the optical recording medium 10 is stored at a high temperature, the first light transmission film 15a shrinks, whereby the optical recording medium 10 is liable to be bent, cracks may be generated in the optical recording medium 10 and the mechanical strength of the optical recording medium 10 is lowered.

In view of the above, it is preferable for the first light transmission film 15a to have low hardness in order to increase the recording sensitivity of the optical recording medium 10 and prevent the mechanical strength of the optical recording medium 10 from being lowered but on the other hand, it is preferable for the first light transmission film 15a to have high hardness in order to improve the jitter property and other characteristics of a signal reproduced from the optical recording medium 10. However, in a study done by the inventors of the present invention, it was found that in the case where the first light transmission film 15a had Vickers hardness of 30 mgf/μm² to 50 mgf/μm², it was possible to improve the recording characteristics of the optical recording medium 10 and prevent the mechanical strength of the optical recording medium 10 from being lowered and it was possible to simultaneously improve the characteristics of a signal reproduced from the optical recording medium 10.

Therefore, in this embodiment, the first light transmission film 15a has Vickers hardness of 30 mgf/μm² to 50 mgf/μm².

Since the material used for forming a light transmission layer normally has Vickers hardness of about 19 mgf/μm² to 22 mgf/μm², it can be seen that the first light transmission film 15a of the optical recording medium 10 according to this embodiment has high Vickers hardness.

The first light transmission film 15a preferably has Vickers hardness of 33 mgf/μm² to 50 mgf/μm² and more preferably has Vickers hardness of 30 mgf/μm² to 42 mgf/μm².

On the other hand, the hardness of the second light transmission film 15b is not particularly limited but the second light transmission film 15b preferably has lower hardness than that of the first light transmission film in order to easily form the second light transmission film 15b. Concretely, the second light transmission film 15b preferably has Vickers hardness of about 0.2 mgf/μm² to 25 mgf/μm².

The material for forming each of the first light transmission film 15a and the second light transmission film 15b is not particularly limited insofar as it has sufficiently high light transmittance with respect to a laser beam having a wavelength of 370 nm to 425 nm, and ultraviolet ray curable resin, electron beam curable resin, thermoplastic resin or the like can be used for each of the first light transmission film 15a and the second light transmission film 15b. Preferably, each of the first light transmission film 15a and the second light transmission film 15b is formed of acrylic or epoxy ultraviolet ray curable resin.

The light transmission layer 15 is preferably formed so that the total thickness of the first light transmission film 15a and the second light transmission film 15b is 10 μm to 300 μm and more preferably formed so that the total thickness of the first light transmission film 15a and the second light transmission film 15b is 15 μm to 200 μm.

The thickness of the first light transmission film 15a is not particularly limited but it is preferable to form the first light transmission film 15a so as to have a thickness of 0.5 μm to 100 μm and it is more preferable to form the first light transmission film 15a so as to have a thickness of 0.5 μm to 50 μm.

In the case where the first light transmission film 15a has a thickness thinner than 0.5 μm, it is difficult to improve the recording characteristics of the optical recording medium 10 and the characteristics of a signal reproduced from the optical recording medium 10 and in the case where the first light transmission film 15a has a thickness thicker than 100 μm, the optical recording medium 10 is liable to be bent and cracks are liable to be generated in the optical recording medium 10.

On the other hand, it is sufficient for the second light transmission film 15b to have a thickness determined in accordance with the thickness of the first light transmission film 15a.

The optical recording medium 10 having the above-described configuration can, for example, be fabricated in the following manner.

The support substrate 11 having the groove 11a and the land 11d on the surface thereof is first fabricated by injection molding using a stamper (not shown).

The support substrate 11 may be fabricated using a photopolymer (2P) process or the like.

The reflective layer 12 is further formed on the surface of the support substrate 11.

The reflective layer 12 can be formed by a gas phase growth process using chemical species containing elements for forming the reflective layer 12. Illustrative examples of the gas phase growth processes include vacuum deposition process, sputtering process and the like but the sputtering process is preferably employed.

The recording layer 13 is then formed on surface of the reflective layer 12.

The recording layer 13 is preferably formed by dissolving the porphyrin system dye, the mono-methine cyanine system dye or the tri-methine cyanine system dye in a solvent to prepare a coating solution, applying the coating solution onto the reflective layer 12 using a spin coating process to form a coating film and drying the coating film.

The recording layer 13 may be formed using a screen printing process, a dip coating process or the like instead of the spin coating process.

In the case of forming the recording layer 13 containing the porphyrin system dye as a primary component, it is preferable to prepare a coating solution by dissolving the porphyrin system dye into a ketone system solvent whose carbon number is 5 to 7. The ketone system solvent may have a chain structure or a ring-shaped structure but a ketone system solvent having a linear chain structure and a branch structure is preferable. Illustrative examples of a ketone system solvent whose carbon number is 5 to 7 and having a linear chain structure and a branch structure include 3-pentanone, methyl isobutyl ketone, 3-hexanone, 2-hexanone(butyl ketone), 4-heptanone, 2-heptanone. It is more preferable to employ as the ketone system solvent for dissolving the porphyrin system dye one whose carbon number is 6, particularly, one whose carbon number is 6 and which has a linear chain structure and a branch structure Illustrative examples of such ketone system solvents include methyl isobutyl ketone, 3-hexanone and 2-hexanone(butyl methyl ketone).

On the other hand, in the case of forming the recording layer 13 containing the mono-methine cyanine system dye, it is possible to select the solvent in accordance with the kind of the mono-methine cyanine system dye from among an alcohol system solvent, a ketone system solvent, an ester system solvent, an ether system solvent, an aromatic system solvent, an alcohol fluoride system solvent, an alkyl halide system solvent and the like and dissolve the mono-methine cyanine system dye thereinto, thereby preparing a coating solution. Among these, 2, 2, 3, 3-tetrafluoro-propanol is preferably used as a solvent for dissolving the mono-methine cyanine system dye.

In the case of forming the recording layer 13 containing the tri-methine cyanine system dye, it is possible to select the solvent in accordance with the kind of the tri-methine cyanine system dye from among an alcohol system solvent, a ketone system solvent, an ester system solvent, an ether system solvent, an aromatic system solvent, an alcohol fluoride system solvent, an alkyl halide system solvent and the like and dissolve the tri-methine cyanine system dye thereinto, thereby preparing a coating solution. Among these, a 2, 2, 3, 3-tetrafluoro-propanol is preferably used as a solvent for dissolving the mono-methine cyanine system dye.

The cap layer 14 is formed on the surface of the recording layer 13.

The cap layer 14 can be formed by a gas phase growth process using chemical species containing elements for forming the cap layer 14. Illustrative examples of the gas phase growth processes include vacuum deposition process, sputtering process and the like but the sputtering process is preferably employed.

Then, the first light transmission film 15a is formed on the surface of the cap layer 14.

The first light transmission film 15a can be formed, for example, by applying a resin solution prepared by dissolving acrylic ultraviolet ray curable resin, epoxy ultraviolet ray curable resin or the like into a solvent and having adjusted viscosity onto the surface of the cap layer 14 using a spin coating process to form a coating film and irradiating the coating film with ultraviolet rays under nitrogen gas atmosphere to cure the coating film.

Further, the second light transmission film 15b is formed on the surface of the first light transmission film 15a.

The second light transmission film 15b can be formed, for example, by applying a resin solution prepared by dissolving acrylic ultraviolet ray curable resin, epoxy ultraviolet ray curable resin or the like into a solvent and having adjusted viscosity onto the surface of the first light transmission film 15a using a spin coating process to form a coating film and irradiating the coating film with ultraviolet rays under nitrogen gas atmosphere to cure the coating film.

Instead of forming the first light transmission film 16a and the second light transmission film 15b using a spin coating process, it is possible to form an adhesive layer by applying a light transmittable adhesive agent onto the cap layer 14 and adhere a light transmittable resin sheet onto the adhesive layer, thereby forming the first light transmission film 15a by the adhesive layer and the second light transmission film 15b by the light transmittable resin sheet.

This completes the fabrication of the optical recording medium 10.

According to this embodiment, the light transmission layer 15 is constituted by the first light transmission film 15a and the second light transmission film and the first light transmission film 15a has Vickers hardness of 30 mgf/μm² to 50 mgf/μm². Therefore, it is possible to improve the data recording sensitivity of the optical recording medium 10 and simultaneously decrease jitter of a reproduced signal to improve the data reproducing characteristics of the optical recording medium 10. Furthermore, it is possible to prevent the optical recording medium 10 from being bent and cracks from being generated in the optical recording medium 10, whereby the mechanical accuracy of the optical recording medium 10 can be improved.

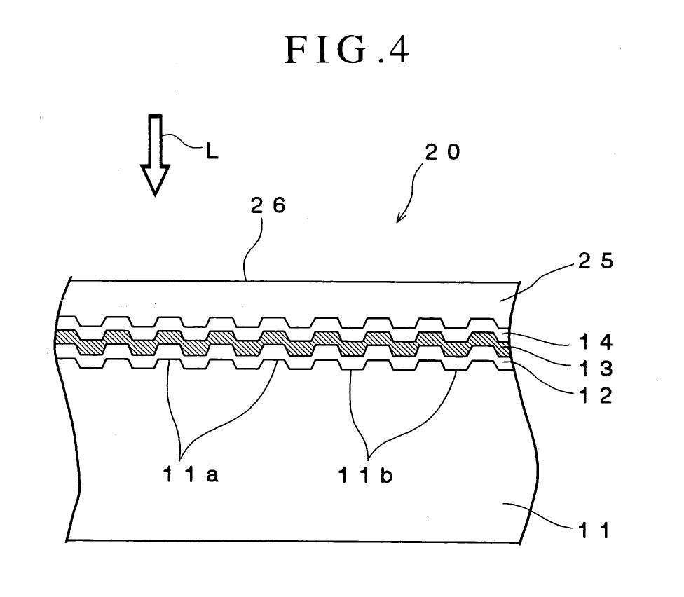

FIG. 4 is a schematic cross-sectional view showing an optical recording medium that is another preferred embodiment of the present invention.

As shown in FIG. 4, the optical recording medium 20 has the same configuration as that of the optical recording medium 10 shown in FIGS. 2 and 3 except that a light transmission layer 25 whose surface constitute a light incidence plane 26 through which a laser beam L enters is constituted as a single light transmission film.

Similarly to the first light transmission film 15a of the optical recording medium 10 shown in FIGS. 2 and 3, in this embodiment, the light transmission layer 25 has Vickers hardness of 30 mgf/μm² to 50 mgf/μm².

In this embodiment, the light transmission layer 25 preferably has Vickers hardness of 33 mgf/μm² to 50 mgf/μm² and more preferably has Vickers hardness of 30 mgf/μm² to 42 mgf/μm².

The material for forming the light transmission layer 25 is not particularly limited insofar as it has sufficiently high light transmittance with respect to a laser beam having a wavelength of 370 nm to 425 nm and ultraviolet ray curable resin, electron beam curable resin, thermoplastic resin or the like can be used for the light transmission layer 25. Preferably, the light transmission layer 25 is formed of acrylic or epoxy ultraviolet ray curable resin.

The light transmission layer 25 is preferably formed so as to have a thickness of 10 μm to 300 μm and more preferably formed so as to have a thickness of 15 μm to 200 μm.

The light transmission layer 25 is preferably formed by applying a resin solution prepared by dissolving acrylic ultraviolet ray curable resin, epoxy ultraviolet ray curable resin or the like into a solvent onto the surface of the cap layer 14 using a spin coating process to form a coating film and irradiating the coating film with ultraviolet rays under nitrogen gas atmosphere to cure the coating film.

According to this embodiment, the light transmission layer 25 of the optical recording medium 20 is constituted as a single light transmission film and the light transmission layer 25 has Vickers hardness of 30 mgf/μm² to 50 mgf/μm². Therefore, it is possible to improve the data recording sensitivity of the optical recording medium 20 and simultaneously decrease jitter of a reproduced signal to improve the data reproducing characteristics of the optical recording medium 20. Furthermore, it is possible to prevent the optical recording medium 20 from being bent and cracks from being generated in the optical recording medium 20, whereby the mechanical accuracy of the optical recording medium 20 can be improved.

### WORKING EXAMPLES AND COMPARATIVE EXAMPLES

Hereinafter, working examples will be set out in order to further clarify the advantages of the present invention.

### Working Example 1

An optical recording medium sample # 1 was fabricated in the following manner.

A disk-like polycarbonate substrate having a thickness of 1.1 mm and a diameter of 120 mm and formed with grooves and lands on the surface thereof was first fabricated by an injection molding process so that the track pitch (groove pitch) was equal to 0.32 μm, the depth of the groove was 60 nm and the peak width at half height of the grooves was 0.16 μm.

Then, the polycarbonate substrate was set on a sputtering apparatus and the polycarbonate substrate on which the grooves and lands were formed was formed thereon with a reflective layer of an alloy consisting of 98 atomic % of Ag, 1 atomic % of Nd and 1 atomic % of Cu so as to have a thickness of 40 nm, using the sputtering process.

Further, the polycarbonate substrate formed with the reflective layer on the surface thereof was set on a spin coating apparatus and a coating solution prepared by dissolving a porphyrin system dye represented by the following structural formula into methyl isobutyl ketone was applied onto the reflective layer using a spin coating process to form the recording layer so that the thickness thereof at the lands was 35 nm.

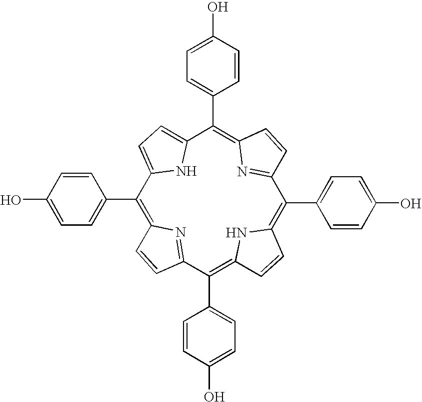

The refractive index with respect to a laser beam having a wavelength of 405 nm of the porphyrin system dye was 0.80 and the extinction coefficient thereof was 0.87.

Further, the polycarbonate substrate formed with the reflective layer and the recording layer on the surface thereof was set on the spin coating apparatus and a cap layer containing a mixture of ZnS and SiO₂ and having a thickness of 30 nm was formed.

The mole ratio of ZnS to SiO₂ in the mixture of ZnS and SiO₂ contained in the cap layer was 80:20.

The polycarbonate substrate formed with the reflective layer, the recording layer and the cap layer on the surface thereof was then set on the spin coating apparatus and ultraviolet ray curable resin “MD450” (Product Name) manufactured by Nippon Kayaku Co., Ltd. was applied onto the cap layer using a spin coating process to form a coating layer and the coating layer was irradiated with ultraviolet rays under a nitrogen gas atmosphere to be cured, thereby forming a first light transmission film having a thickness of 15 μm.

The total amount of the projected ultraviolet rays was 3170 J and the Vickers hardness of the first light transmission film was 34 mgf/μm².

Then, the surface of the first light transmission film was coated with a solution prepared by mixing 60 weight % of difunctional urethane acrylate oligomer “ARONIX M-1100” (Product Name) manufactured by Toagosei Chemical Industry Co., Ltd., 20 weight % of trimethylolpropane triacrylate “ARONIX M-309” (Product Name) manufactured by Toagosei Chemical Industry Co., Ltd., 17 weight % of cyclopentanyl acrylate “FA-513A” (Product Name) manufactured by Hitachi Chemical Co., Ltd. and 3 weight % of 1-hydroxy-cyclohexyl-phenyl-ketone “IRG184” manufactured by Ciba Specialty Chemicals K.K. using a spin coating process to form a coating layer and the coating layer was irradiated with an ultraviolet rays under the nitrogen gas atmosphere to be cured, thereby forming a second light transmission film having a thickness of 85 μm.

The total amount of the projected ultraviolet rays was 3170 J and the Vickers hardness of the second light transmission film was 15 mgf/μm².

Thus, the optical recording medium sample #1 was fabricated.

Then, an optical recording medium sample #2 was fabricated in the same way as the optical recording medium sample #1 except that a first light transmission film having a thickness of 10 μm and a second light transmission film having a thickness of 90 μm were formed using ultraviolet ray curable resin “UV3701” (Product Name) manufactured by Toagosei Chemical Industry Co., Ltd. instead of ultraviolet ray curable resin “MD450” (Product Name) manufactured by Nippon Kayaku Co., Ltd.

The Vickers hardness of the first light transmission film of the optical recording medium sample #2 was 42 mgf/μm².

Further, an optical recording medium sample #3 was fabricated in the same way as the optical recording medium sample #1 except that a first light transmission film having a thickness of 5 μm and a second light transmission film having a thickness of 95 μm were formed using a resin solution prepared by mixing 47 weight % of propylene glycol monomethyl ether, 23 weight % of colloidal silica manufactured by Nissan Chemical Industries, Ltd., 22 weight % of dipentaerythritol hexaacrylate, 6 weight % of tetrahydrofurfuryl acrylate and 2 weight % of 1-hydroxy-cyclohexyl-phenyl-ketone “IRG184” manufactured by Ciba Specialty Chemicals K.K. instead of ultraviolet ray curable resin “MD450” (Product Name) manufactured by Nippon Kayaku Co., Ltd.

The Vickers hardness of the first light transmission film of the optical recording medium sample #3 was 49 mgf/μm².

Furthermore, an optical recording medium sample #4 was fabricated in the same way as the optical recording medium sample #1 except that a first light transmission film having a thickness of 10 μm and a second light transmission film having a thickness of 90 μm were formed using ultraviolet ray curable resin “HOD3200” (Product Name) manufactured by Nippon Kayaku Co., Ltd. instead of ultraviolet ray curable resin “MD450” (Product Name) manufactured by Nippon Kayaku Co., Ltd.

The Vickers hardness of the first light transmission film of the optical recording medium sample #4 was 30 mgf/μm².

Then, an optical recording medium comparative sample #1 was fabricated in the same way as the optical recording medium sample #1 except that a first light transmission film having a thickness of 5 μm and a second light transmission film having a thickness of 95 μm were formed using a resin solution prepared by mixing 48 weight % of propylene glycol monomethyl ether, 21 weight % of colloidal silica manufactured by Nissan Chemical Industries, Ltd., 23 weight % of dipentaerythritol hexaacrylate, 6 weight % of tetrahydrofurfuryl acrylate and 2 weight % of 1-hydroxy-cyclohexyl-phenyl-ketone “IRG184” manufactured by Ciba Specialty Chemicals K.K. instead of ultraviolet ray curable resin “MD450” (Product Name) manufactured by Nippon Kayaku Co., Ltd.

The Vickers hardness of the first light transmission film of the optical recording medium comparative sample #1 was 51 mgf/μm².

Further, an optical recording medium comparative sample #2 was fabricated in the same way as the optical recording medium sample #1 except that a first light transmission film was formed using ultraviolet ray curable resin “SPC850” (Product Name) manufactured by Nippon Kayaku Co., Ltd. instead of ultraviolet ray curable resin “MD450” (Product Name) manufactured by Nippon Kayaku Co., Ltd.

The Vickers hardness of the first light transmission film of the optical recording medium comparative sample #2 was 26 mgf/μm².

Then, an optical recording medium comparative sample #3 was fabricated in the same way as the optical recording medium sample #1 except that a first light transmission film was formed using ultraviolet ray curable resin “XNR5535” (Product Name) manufactured by NAGASE CO., LTD. instead of ultraviolet ray curable resin “MD450” (Product Name) manufactured by Nippon Kayaku Co., Ltd.

The Vickers hardness of the first light transmission film of the optical recording medium comparative sample #3 was 21 mgf/μm².

Further, an optical recording medium comparative sample #2 was fabricated in the same way as the optical recording medium sample #1 except that no first light transmission film was formed and a second light transmission film having a thickness of 100 μm was formed on the cap layer.

The Vickers hardness of the second light transmission film of the optical recording medium comparative sample #4 was 15 mgf/μm².

Then, an optical recording medium comparative sample #5 was fabricated in the same way as the optical recording medium sample #1 except that a first light transmission film was formed using ultraviolet ray curable resin “SD318” (Product Name) manufactured by DAINIPPON INK AND CHEMICALS INC. instead of ultraviolet ray curable resin “MD450” (Product Name) manufactured by Nippon Kayaku Co., Ltd.

The Vickers hardness of the first light transmission film of the optical recording medium comparative sample #5 was 29 mgf/μm².

Furthermore, the surface of a polycarbonate sheet having a thickness of 75 μm and manufactured by Sekisui Chemical Co., Ltd. was coated with an acrylic adhesive agent “BPS5511” (Product Name) manufactured by Toyo Ink Manufacturing Co., Ltd., thereby forming an adhesive agent layer having a thickness of 25 μm and the adhesive agent layer was bonded under reduced pressure onto the surface of the cap layer formed on the polycarbonate substrate in a similar manner to that of the optical recording medium sample #1 to fabricate an optical recording medium comparative sample #6 in which a first light transmission layer was constituted as the adhesive agent layer and a second light transmission layer was constituted as the polycarbonate sheet.

The Vickers hardness of the first light transmission film of the optical recording medium comparative sample #6 was 0.2 mgf/μm².

Then, an optical recording medium comparative sample #7 was fabricated in the same way as the optical recording medium sample #1 except that a first light transmission film having a thickness of 0.4 μm was formed using a resin solution prepared by mixing 96 weight % of propylene glycol monomethyl ether, 1.6 weight % of colloidal silica manufactured by Nissan Chemical Industries, Ltd., 1.8 weight % of dipentaerythritol hexaacrylate, 0.4 weight % of tetrahydrofurfuryl acrylate and 0.2 weight % of 1-hydroxy-cyclohexyl-phenyl-ketone “IRG184” manufactured by Ciba Specialty Chemicals K.K. instead of ultraviolet ray curable resin “MD450” (Product Name) manufactured by Nippon Kayaku Co., Ltd. and a second light transmission film having a thickness of 100 μm was formed.

The Vickers hardness of the first light transmission film of the optical recording medium comparative sample #7 was 45 mgf/μm².

Further, a light transmittable film having a thickness of 5 μm was formed in the same manner as that for forming the first light transmission film of the optical recording medium sample #3 and a first light transmission layer having a thickness of 105 μm was formed by repeating this operation, thereby fabricating an optical recording medium comparative sample # 8 without forming a second light transmission film.

The Vickers hardness of the first light transmission film of the optical recording medium comparative sample #8 was 49.4 mgf/μm².

The Vickers hardness was measured using a nano indentation tester “ENT-1100” (Product Name) manufactured by ELIONIX CO., LTD. in such a manner that a load of 200 mgf was applied to each sample for two seconds and the load was removed from each sample.

Further, each of the optical recording medium samples #1 to 4 and the optical recording medium comparative samples #1 to #8 was set in an optical recording medium evaluation apparatus “DDU1000” (Product Name) manufactured by Pulstec Industrial Co., Ltd. and a laser beam having a wavelength of 405 nm was focused onto the recording layer using an objective lens whose numerical aperture was 0.85 via the light transmission layer while each of the samples was rotated at a linear velocity of 5.28 m/sec, thereby recording random signals including a 2T signal to an 8T signal therein in the 1,7 RLL Modulation Code.

The recording power of the laser beam was set to 7.0 mW, while the bottom power of the laser beam was fixed at 0.1 mW.

The length of a 2T signal was 160 nm.

Then, each of the optical recording medium samples #1 to 4 and the optical recording medium comparative samples #1 to #8 was set in the above mentioned optical recording medium evaluation apparatus and a laser beam having a wavelength of 405 nm was focused onto the recording layer of each sample using an objective lens whose numerical aperture was 0.85 via the light transmission layer while each sample was rotated at a linear velocity of 5.3 m/sec, thereby reproducing a signal recorded in the recording layer and jitter of the reproduced was measured.

Further, similarly to the above, random signals including a 2T signal to an 8T signal were recorded in each of the optical recording medium samples #1 to 4 and the optical recording medium comparative samples #1 to #8 while increasing the recording power of the laser beam in increments of 0.2 mW up to 10.0 mW, thereby reproducing a signal from each sample and measuring jitter thereof similarly to the above was measured.

The lowest jitter was determined from among the thus measured jitters and the recording power at which the jitter of the reproduced signal was lowest was determined as an optimum recording power of the laser beam.

The thus determined optimum recording power of the laser beam for each sample was shown in Table 1.

Further, each of the optical recording medium samples #1 to 4 and the optical recording medium comparative samples #1 to #8 was stored under the temperature of 80 degrees for one hundred hours, thereby performing a storage test and the mechanical accuracy of each sample was measured using a disc warpage checker “DC-1010C” (Product Name) manufactured by Cores Co., Ltd.

The results of the measurement are shown in Table 1.

In Table 1, when a sample was greatly bent after the storage test, the mechanical accuracy of the sample was rated BAD and otherwise, it was rated GOOD.

TABLE 1

| | Jitter | Optimum Recording | Mechanical |
|---|---|---|---|
| Sample # | (%) | Power (mW) | Accuracy |
| Sample #1 | 9.2 | 10.6 | GOOD |
| Sample #2 | 9.1 | 10.9 | GOOD |
| Sample #3 | 9.3 | 11.7 | GOOD |
| Sample #4 | 9.9 | 10.4 | GOOD |
| Comparative Sample #1 | 9.8 | 12.0 | BAD |
| Comparative Sample #2 | 11.0 | 10.2 | GOOD |
| Comparative Sample #3 | 12.5 | 9.8 | GOOD |
| Comparative Sample #4 | 14.5 | 9.7 | GOOD |
| Comparative Sample #5 | 10.2 | 10.0 | GOOD |
| Comparative Sample #6 | 22.3 | 9.4 | GOOD |
| Comparative Sample #7 | 14.3 | 9.6 | GOOD |
| Comparative Sample #8 | 9.4 | 11.8 | BAD |

As shown in Table 1, it was found that in each of the optical recording medium samples #1 to #4 each including a first light transmission layer having Vickers hardness of 30 mgf/μm² to 50 mgf/μm², jitter of the reproduced signal was lower than 10 % and the optimum recording power was lower than 12 mW. Moreover, each of the optical recording medium samples #1 to #4 had not only practical signal reproducing characteristics and recording sensitivity but also practical mechanical accuracy. Particularly noteworthy is that in each of the optical recording medium samples #1 to #3 each including the first light transmission layer having Vickers hardness of 33 mgf/μm² to 50 mgf/μm², jitter of the reproduced signal was lower than 9.5 % and the signal reproducing characteristics were good. It was further found that in each of the optical recording medium samples #1 and #2 each including the first light transmission layer having Vickers hardness of 33 mgf/μm² to 42 mgf/μm², jitter of the reproduced signal was lower than 9.5%, the optimum recording power was lower than 11 mW and the signal reproducing characteristics and recording sensitivity were good.

To the contrary, it was found that in each of the optical recording medium comparative samples #2, #3 and #6 each including the first light transmission layer having Vickers hardness lower than 30 mgf/μm² and the optical recording medium comparative sample #4 including the second light transmission layer having Vickers hardness lower than 30 mgf/μm², jitter of the reproduced signal was equal to or higher than 11 % and the signal reproducing characteristics were poor.

Further, it was found that in the optical recording medium comparative sample 7, although Vickers hardness of the first light transmission layer was 30 mgf/μm² to 50 mgf/μm², since the first light transmission layer had a thickness smaller than 0.5 μm and was too thin, jitter of the reproduced signal was higher than 14% and the signal reproducing characteristics were poor.

Furthermore, it was found that in the optical recording medium comparative sample #8, the signal reproducing characteristics and recording sensitivity were good because Vickers hardness of the first light transmission layer was 30 mgf/μm² to 50 mgf/μm², but that since the first light transmission layer had excessive thickness of greater than 100 μm, storage reliability was degraded as evidenced by bending observed after the storage test. Moreover, in the optical recording medium comparative sample #1 including the first light transmission layer having Vickers hardness higher than 50 mgf/μm², the optimum recording power was equal to or higher than 12 mW and the recording sensitivity was low, while storage reliability was also degraded as evidenced by bending observed after the storage test.

The present invention has thus been shown and described with reference to specific embodiments and working examples. However, it should be noted that the present invention is in no way limited to the details of the described arrangements but changes and modifications may be made without departing from the scope of the appended claims.

For example, the optical recording medium 10 is provided with the light transmission layer 15 including the first light transmission film 15a and the second light transmission film 15b in the embodiment shown in FIGS. 2 and 3 and the optical recording medium 20 is provided with the light transmission layer 25 constituted as a single light transmission film in the embodiment shown in FIG. 3. However, a light transmission layer may be constituted by three of more light transmission films insofar as a light transmission film closest to the recording layer 13 has Vickers hardness equal to or higher than 30 mgf/μm² and equal to or lower than 50 mgf/μm².

Further, in the above described embodiments, although the optical recording medium 10, 20 includes a single recording layer 13, an optical recording medium may be constituted so that it includes a plurality of recording layers laminated via a transparent intermediate layer(s) and the transparent intermediate layer(s) and the light transmission layer or the light transmission film closest to the recording layer located closest to the light incidence plane 16, 26 have Vickers hardness equal to or higher than 30 mgf/μm² and equal to or lower than 50 mgf/μm².

Furthermore, in the above described embodiments, although the optical recording medium 10, 20 includes the reflective layer 12 and it is preferable to provide the reflective layer 12 in order to obtain a higher reproduced signal (C/N ratio) by a multiple interference effect, it is not absolutely necessary for the optical recording medium 10, 20 to include the reflective layer 12.

Moreover, the light incidence plane 16 is constituted by the surface of the second light transmission film 15b in the embodiment shown in FIGS. 2 and 3 and the light incidence plane 26 is constituted by the surface of the light transmission layer 25 in the embodiment shown in FIG. 3. However, it is possible to form a hard coat layer on the surface of the second light transmission film 15b or the light transmission layer 25, thereby protecting it.

According to the present invention, it is possible to provide an optical recording medium including a recording layer containing an organic dye as a primary component and a light transmission layer, which achieves improved recording sensitivity and other recording characteristics and improved jitter property and other reproduced signal characteristics.

1. An optical recording medium comprising a support substrate, a light transmission layer formed on a side of a light incidence plane through which a laser beam is projected and which comprises at least one light transmission film and a recording layer located between the support substrate and the light transmission layer and containing an organic dye as a primary component, the at least one light transmission film having Vickers hardness of 30 mgf/μm² to 50 mgf/μm² with respect to a load of 200 mgf.

2. An optical recording medium in accordance with claim 1, wherein the at least one light transmission film has Vickers hardness of 33 mgf/μm² to 50 mgf/μm².

3. An optical recording medium in accordance with claim 2, wherein the at least one light transmission film has Vickers hardness of 33 mgf/μm² to 42 mgf/μm².

4. An optical recording medium in accordance with claim 1, wherein the at least one light transmission film is formed so as to have a thickness of 0.5 μm to 100 μm.

5. An optical recording medium in accordance with claim 1, wherein the light transmission layer comprises a first light transmission film which is located on the side of the recording layer and has Vickers hardness of 30 mgf/μm² to 50 mgf/μm² with respect to a load of 200 mgf and a second light transmission film located on the side of the light incidence plane through which a laser beam enters.

6. An optical recording medium in accordance with claim 5, wherein the first light transmission film has Vickers hardness of 33 mgf/μm² to 50 mgf/μm².

7. An optical recording medium in accordance with claim 6, wherein the first light transmission film has Vickers hardness of 33 mgf/μm² to 42 mgf/μm².

8. An optical recording medium in accordance with claim 5, wherein the first light transmission film so as to have a thickness of 0.5 μm to 100 μm.

9. An optical recording medium in accordance with claim 5, wherein the second light transmission film has hardness lower than that of the first light transmission film.

10. An optical recording medium in accordance with claim 5, wherein each of the first light transmission film and the second light transmission film is formed by applying a resin solution using a spin coating process.

11. An optical recording medium in accordance with claim 5, wherein the first light transmission film is constituted as an adhesive layer formed of a light transmittable adhesive agent layer and the second light transmission film is formed by adhering a light transmittable sheet onto the adhesive layer.

12. An optical recording medium in accordance with claim 1, wherein the thickness of the light transmission layer is equal to or thicker than 10 μm and equal to or thinner than 300 μm.

13. An optical recording medium in accordance with claim 5, wherein the thickness of the light transmission layer is equal to or thicker than 10 μm and equal to or thinner than 300 μm.

14. An optical recording medium in accordance with claim 1, which further comprises a reflective layer between the support substrate and the recording layer.

15. An optical recording medium in accordance with claim 5, which further comprises a reflective layer between the support substrate and the recording layer.

16. An optical recording medium in accordance with claim 1, which further comprises a cap layer between the light transmission layer and the recording layer.

17. An optical recording medium in accordance with claim 5, which further comprises a cap layer between the light transmission layer and the recording layer.

18. An optical recording medium in accordance with claim 1, wherein the cap layer is formed of a dielectric material so as to have thickness of 10 nm to 150 nm.

19. An optical recording medium in accordance with claim 5, wherein the cap layer is formed of a dielectric material so as to have thickness of 10 nm to 150 nm.

20. An optical recording medium in accordance with claim 1, wherein the cap layer is formed of metal so as to have thickness of 10 nm to 20 nm.

21. An optical recording medium in accordance with claim 5, wherein the cap layer is formed of metal so as to have thickness of 10 nm to 20 nm.

22. An optical recording medium in accordance with claim 1, wherein an organic dye contained in the recording layer as a primary component has a refractive index lower than 1.2 or higher than 1.9 with respect to a laser beam having a wavelength of 370 nm to 425 nm and an extinction coefficient equal to or higher than 0.1 and equal to or lower than 1.0 with respect to a laser beam having a wavelength of 370 nm to 425 nm.

23. An optical recording medium in accordance with claim 5, wherein an organic dye contained in the recording layer as a primary component has a refractive index lower than 1.2 or higher than 1.9 with respect to a laser beam having a wavelength of 370 nm to 425 nm and an extinction coefficient equal to or higher than 0.1 and equal to or lower than 1.0 with respect to a laser beam having a wavelength of 370 nm to 425 nm.

24. An optical recording medium in accordance with claim 1, wherein the recording layer contains a porphyrin system dye, a mono-methine cyanine system dye or a tri-methine cyanine system dye as a primary component.

25. An optical recording medium in accordance with claim 5, wherein the recording layer contains a porphyrin system dye, a mono-methine cyanine system dye or a tri-methine cyanine system dye as a primary component.
